(19) United States
(12) Patent Application Publication
(10) Pub. No.: US 2006/0111158 A1
(43) Pub. Date: May 25, 2006

(54) Sliding-type Electronic Device with a Semi-Automatic Opening Mechanism

(76) Inventor: Kai-Chung Hou, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/163,257

(22) Filed: Oct. 12, 2005

(30) Foreign Application Priority Data
Nov. 19, 2004 (TW) 093135772

(51) Int. Cl. H04M 1/00

(52) U.S. Cl. 455/575.1

(57) ABSTRACT

An electronic device includes a first module including a fixed component. Widths of the front end to the transition part being gradually increasing, and widths of the rear end to the transition part being gradually increasing. The wireless communication further includes a second module connected to the first module in a sliding manner. The second module includes a thrust component for pushing against a first contact surface of the fixed component between the front end and the transition part or pushing against a second contact surface of the fixed component between the rear end and the transition part. The electronic device provides convenience as a user is only required to slide the electronic device, such as a mobile phone, to surpass a predetermined distance and the electronic device will then continue to execute the movement of opening or closing automatically.

### BACKGROUND OF THE INVENTION

1. Field of the Invention

The present invention relates to an electronic device, more particularly, an electronic device with a semi-automatic opening mechanism.

2. Description of the Prior Art

In our highly developed information communication systems in the modern information society, electronic devices are widely utilized in every area of daily life. For instance, the utilization of a convenient and lightweight mobile phone device has become a critical way of communication. Phone users can easily exchange and share information through the convenience of the mobile phone. The development of mobile phones has progressed tremendously in recent years. The increasing utilization has created a demand in mobile phone production. This current trend in mobile phone technology is moving towards smaller multi-functional phones. An important issue is how to design mobile phones that are more convenient to operate.

Mobile phones have certain designs that facilitate the functions of “opening” the device. Current industrial designs for opening of the mobile phone exist in the market. One design, for example, involves a slide construction. The slide construction is especially popular in the high-end market segment. Please compare the slide construction mobile phone to that of the straight vertical mobile phone. It is obvious that the size of the slide construction mobile phone is smaller when it is shut (i.e., closed) and the surface area of keypads is wider. Unfortunately, the slide mechanism of the slide construction mobile phone operates predominantly in a manual fashion. If a handset is long and it needs a longer opening distance, it appears to be inconvenient for the user to operate. This is especially evident when the user has small hands. A user with smaller hands who wishes to perform the opening function of a slide construction mobile phone utilizing a single hand will have trouble. A phenomenon will occur where the phone cannot be completely open, thus this creates inconvenience for the user.

### SUMMARY OF THE INVENTION

The claimed invention relates to an electronic device with a semi-automatic opening mechanism to solve the problem mentioned above.

The claimed invention discloses an electronic device comprising a first module further comprising a fixed component having a front end and a rear end, and a transition part located in between the front end and the rear end, widths of the front end to the transition part being gradually increasing, widths of the rear end to the transition part being gradually increasing, and a second module comprising a thrust component for pushing against a first contact surface of the fixed component between the front end and the transition part or pushing against a second contact surface of the fixed component between the rear end and the transition part.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an external view diagram of an electronic device.

FIG. 2 illustrates an internal structure diagram of a first module.

FIG. 3 illustrates a second internal structure diagram of a first module.

FIG. 4 illustrates an internal structure diagram of a second module.

FIG. 5 illustrates a diagram of a thrust head being compressed.

FIG. 6 illustrates a diagram of a thrust head snapping back.

FIG. 7 illustrates a diagram of a first module combining with a second module when an electronic device is completely open.

FIG. 8 illustrates a diagram of a first module combining with a second module when an electronic device is half open.

FIG. 9 illustrates a diagram of a first module combining with a second module when an electronic device is completely closed.

FIG. 10 illustrates a force analysis diagram of when a thrust head contacts a first contact surface.

FIG. 11 illustrates a force analysis diagram of when a thrust head contacts a second contact surface.

FIG. 12 illustrates a force analysis diagram of when a thrust head contacts a transition part of a fixed component.

FIG. 13 illustrates an internal structure diagram of a first module of the second embodiment according the present invention

FIG. 14 illustrates an internal structure diagram of a second module of the second embodiment according to the present invention.

FIG. 15 illustrates a diagram of the first module combining with the second module of the second embodiment according to the present invention.

### DETAILED DESCRIPTION

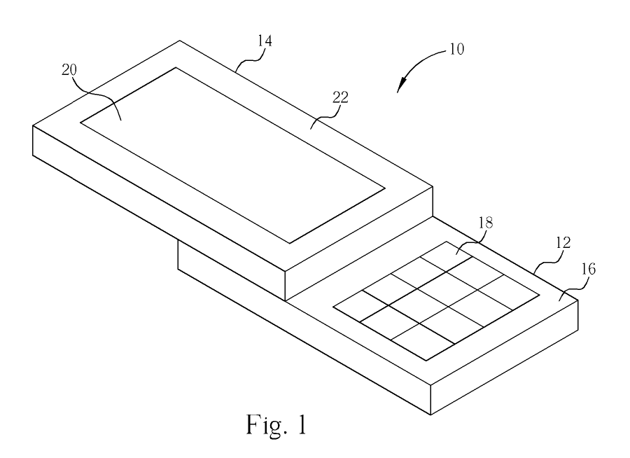

Please refer FIG. 1. FIG. 1 illustrates an external view diagram of an electronic device 10. The electronic device 10 can be a mobile phone, or a personal digital assistant (PDA), and so on. The electronic device 10 comprises a first module 12 and a second module 14. The second module 14 can move in a sliding manner and the second module 14 is fixed above the first module 12. A user can push the second module 14 to achieve opening movement of the electronic device 10. The first module 12 comprises a processing unit (not shown in FIG. 1), installed within a first casing 16 of the first module 12, for controlling operation of the electronic device 10, and a keypad 18, installed on the first casing 16 of the first module 12, for inputting control signals to the processing unit, the user can also perform action of dialing telephone by utilizing the keypad 18. The second module 14 comprises a display panel 20, installed on a second casing 22 of the second module 14, for displaying images processed by the electronic device 10.

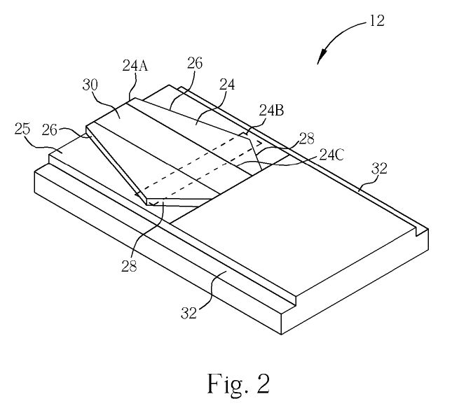

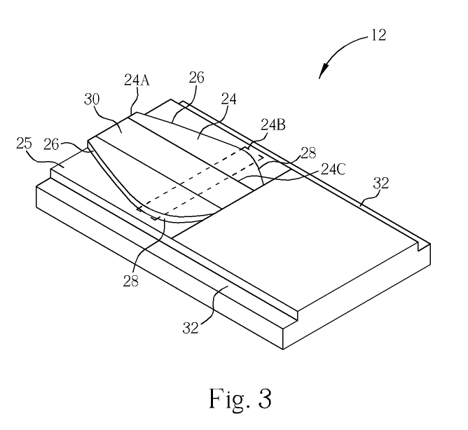

Please refer to FIG. 2. FIG. 2 illustrates an internal structure diagram of a first module 12. The first module 12 comprises a fixed component 24, located on a first flat surface 25 of the first module 12, widths of a first end 24a to a transition part 24b being gradually increasing, widths of a second end 24c to the transition part 24b being gradually increasing, and the first end 24a of the fixed component 24 to part of the transition part 24b at each end comprises two first contact surfaces 26, and the second end 24c of the fixed component 24 to part of the transition spot 24b at each end comprises two second contact surfaces 28. The first contact surface 26 and the second contact surface 28 in this embodiment are two inclined surfaces of different slopes. Please refer to FIG. 3 and at the same time refer to FIG. 2. FIG. 3 illustrates a second internal structure diagram of a first module. Depending on design, the first contact surface 26 and the second contact surface 28 can be two curved surfaces of different curvatures, and connecting point of the first contact surface 26 and the second contact surface 28 is the transition spot 24b, location setting of the transition spot 24b can depend on demand of design as well. The fixed component 24 can be formed by two different components, the first contact surface and the second contact surface 28, or by one body structure of the first contact surface 26 and the second contact surface 28. The fixed component 24, located in between the first contact surface 26 and the second contact surface 28, comprises a hole 30 for a wire connecting between the first module 12 and the second module 14 to pass through. The first module 12 further comprises two trenches 32 for the second module 14 to slide along the first module 12.

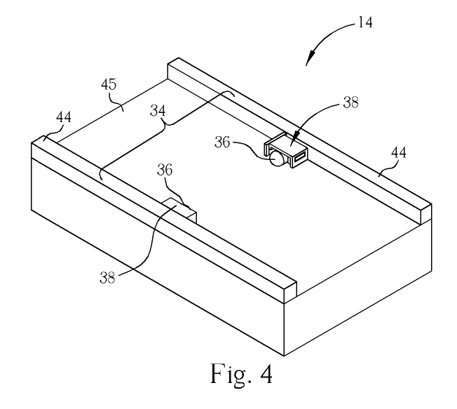

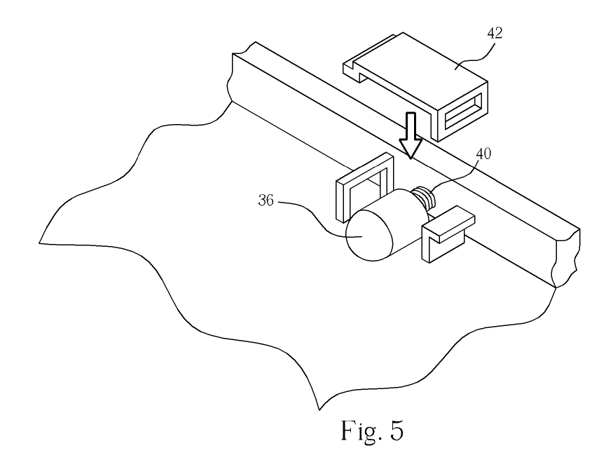

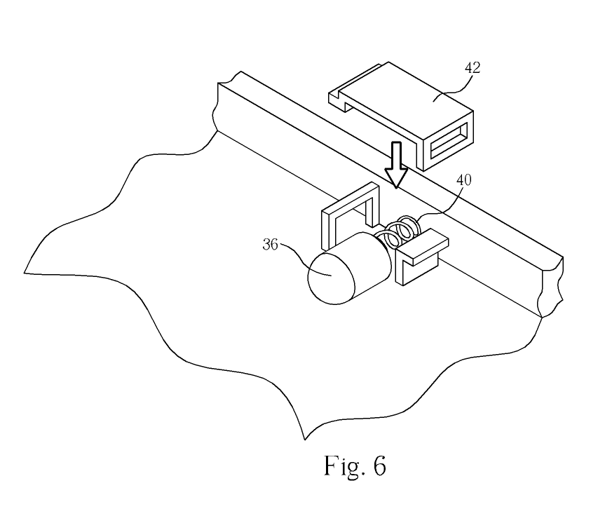

Please refer to FIG. 4. FIG. 4 illustrates an internal structure diagram of a second module 14. The second module 14 comprises a thrust component 34 for providing a thrust to the first contact surface 26 of the fixed component 24 of the first module 12 or for providing a thrust to the second contact surface 28 of the fixed component 24, so that the second module 14 can slide relative to the first module 12. The thrust components 34 are located at two ends of the second module 14. Each comprises a thrust head 36, a bullet-shaped structure, for contacting the first contact surface 26 or the second contact surface 28, and the direction of the thrust head 36 grouped into the thrust component 34 is crossed with the direction of the first module 12 and the second module 14 sliding relatively. As a result, the assembly will not easily fall off. Furthermore, each thrust component 34 comprises a force device 38, for providing a force to the thrust head 36 so that the thrust head 36 pushes against the first contact surface 26 or the second contact surface 26, the force device 38 can comprise a spring, an elastic structure, a magnet, or a torque rod, and so on. The force device 38 in this embodiment utilizes a spring coupled to the thrust head 36. Please refer to FIG. 5 and FIG. 6. FIG. 5 illustrates a diagram of a thrust head 36 being compressed. FIG. 6 illustrates a diagram of a thrust head 36 snapping back. For example, consider if the initial state of a spring 40 of the force device 38 is as shown in FIG. 6 such that the thrust head 36 extends out a predetermined distance to a thrust head cover 42. When the thrust head 36 is not compressed, it will be in the state shown in FIG. 6. If the thrust head 36 is being pressed, then the spring 40 coupled to the thrust head 36 will also be compressed, as a result, as shown in FIG. 5, the thrust head 36 will retract into the thrust head cover 42. When pressure is removed from the thrust head 36 then the thrust head 36 will snap back to the extended position of the thrust head cover 42 as shown in FIG. 6. Please continue to refer to FIG. 4. Additionally, the second module 14 further comprises two sliding tracks 44. The two sliding tracks 44 are installed on the second flat surface 45 of the second module 14. The second flat surface 45 is opposite to the first flat surface 25 of the first module 12. The two sliding tracks 44 are utilized for the second module 14 to slide to the first module 12 on the two trenches 32.

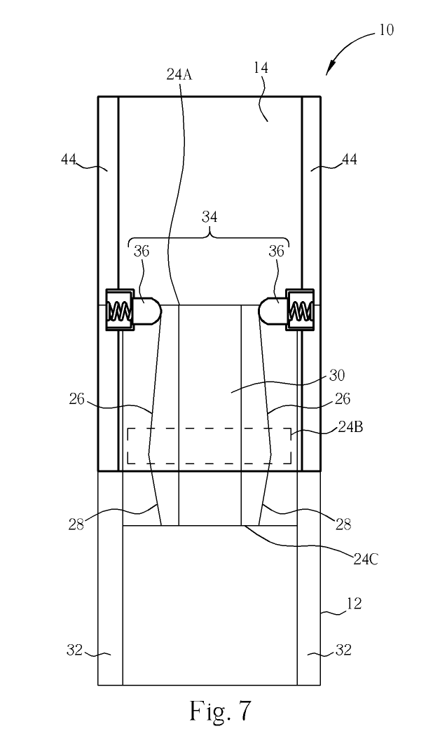

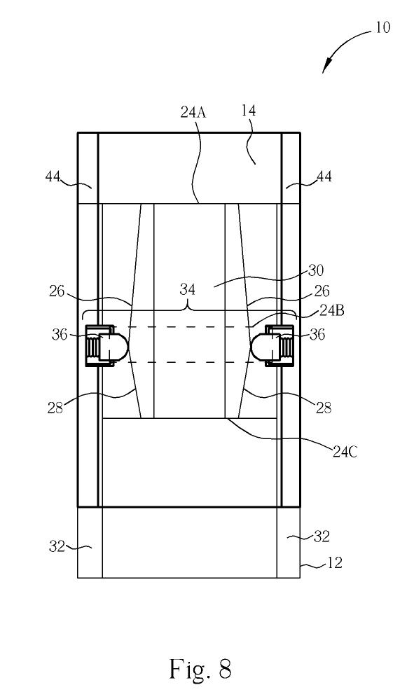

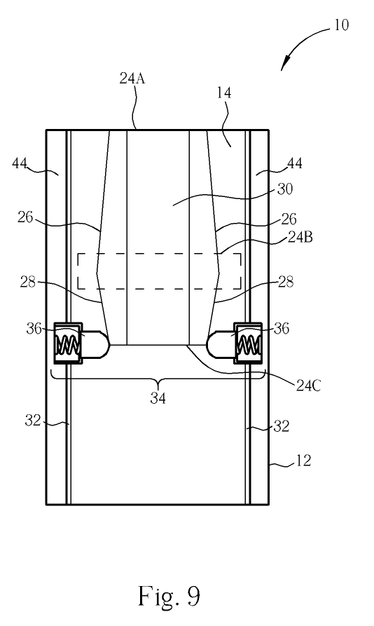

Please refer to FIG. 7 to FIG. 9. FIG. 7 illustrates a diagram of a first module 12 combining with a second module 14 when an electronic device 10 is completely open. FIG. 8 illustrates a diagram of a first module 12 combining with a second module 14 when an electronic device 10 is half open. FIG. 9 illustrates a diagram of a first module 12 combining with a second module 14 when an electronic device is completely closed. The second module 14 can slide along the trenches 32 of the first module 12 on the sliding tracks 44. Simultaneously, when the thrust component 34 of the second module 14 slides along the first contact surface 26 or the second contact surface 28 (the thrust head 36 of the thrust component 34 is in a compression state) the thrust component 34 of the second module 14 can slide along the first contact surface 26 or the second contact surface 28 of the fixed component 34 of the first module 12. Compression displacement of the thrust head 36 is at the maximum when the thrust component 34 moves to the transition part 24b of the fixed component 24 as shown in FIG. 8. However, when the thrust component 34 moves to the first end 24a and the second end 24c of the fixed component 24 as shown in FIG. 7 and FIG. 9, the compression displacement of the thrust head 36 is the least; therefore the thrust head 36 performs a reciprocal motion of a simple harmonic motion in a direction perpendicular to the direction of the first module 12 and the second module 14 sliding relative to each other.

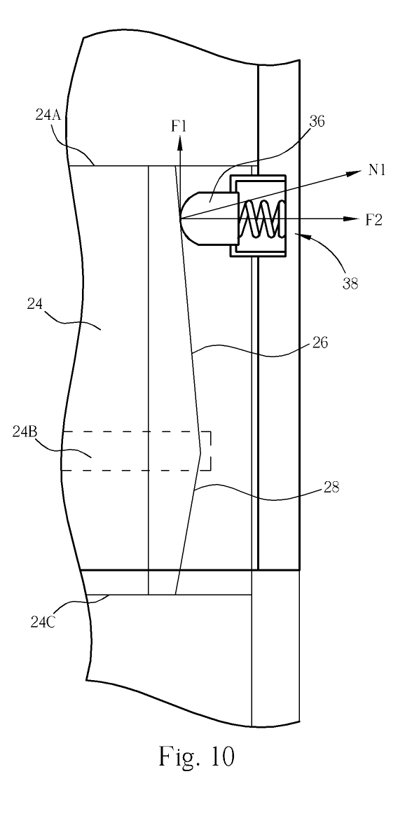

When the user slides the second module 14 upwards relative to the first module 12, and the thrust head 36 of the thrust component 34 surpasses the transition part 24b of the fixed component 24, or when the user slides the second module 14 downwards relative to the first module 12, but the thrust head 36 of the thrust component 34 has not surpassed the transition spot 24b of the fixed component 24, the thrust head 36 contacts the first contact surface 26 of the fixed component 24, at this time even if the user does not exert any force to push the second module 14, the thrust head 36 of the second module 14 will automatically slide to the first end 24a of the fixed component 24 along the first contact surface 26. Please refer to FIG. 10. FIG. 10 illustrates a force analysis diagram of when a thrust head 36 contacts a first contact surface 26. As the thrust head 36 receives a force exerted from the force device 38 to push against the first contact surface 26, a forward force N1 is exerted on the thrust head 36 in the direction of the first contact surface 26 on the fixed component 24 vertically, and the forward force N1 can be analyzed as a horizontal force F1 of the first module 12 and the second module 14 sliding in relative directions, and a vertical force F2 of the first module 12 and the second module 14 sliding in relative directions. The force F1 causes the thrust head 36 to slide along horizontally in the direction of the first module 12 and the second module 14 sliding in relative directions, which also means the direction of the electronic device 10 opening, the thrust head will move to the first end 24a of the fixed component 24, and the function of automatic opening is achieved after the thrust head 36 surpasses the transition part 24b of the fixed component 24.

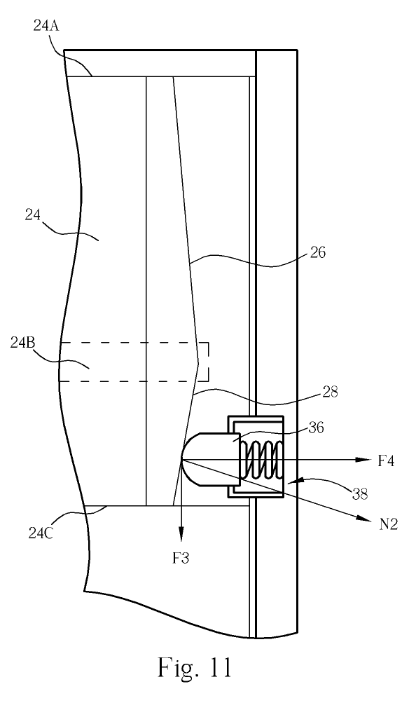

Otherwise, when the user slides the second module 14 upwards to the first module 12, but when the thrust head 36 of the thrust component 34 slides to a position where it does not surpass the transition part 24b of the fixed component 24, or when the user slides the second module 14 downwards to the first module 12 so that the thrust head 36 of the thrust component 34 surpasses the transition part 24b of the fixed component 24, which also means when the thrust head 36 contacts to the second contact surface 28 of the fixed component 24, at this time, even if the user does not exert any force to push the second module 14, the thrust head 36 of the second module 14 will also automatically slide to the second end 24c of the fixed component 24 along the second contact surface 28 of the fixed component 24. Please refer FIG. 11. FIG. 11 illustrates a force analysis diagram of when a thrust head 36 contacts a second contact surface 28. As the thrust head 36 receives force exerted from the force device 38 to push against the second contact surface 28, a forward force N2 is exerted on the thrust head 36 in the direction of the second contact surface 28 on the fixed component 24 vertically, and the forward force N2 can be analyzed as a horizontal force F3 of the first module 12 and the second module 14 sliding in relative directions, and a vertical force F4 of the first module 12 and the second module 14 sliding in relative directions, the force F3 causes the thrust head 36 to slide along horizontally in the direction of the first module 12 and the second module 14 sliding in relative directions, which also means the direction of the electronic device 10 closing, the thrust head will move to the second end 24c of the fixed component 24, and the function of automatic closing is achieved after the thrust head 36 surpasses the transition part 24b of the fixed component 24.

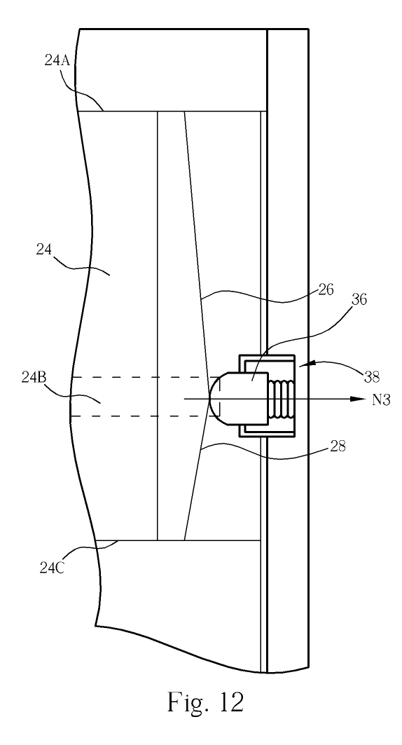

Please refer to FIG. 12. FIG. 12 illustrates a force analysis diagram of when a thrust head 36 contacts a transition part 24b of a fixed component 24. As the thrust head 36 receives force exerted from the force device 38 to push against a transition part 24b of the fixed component 24, a forward force N3 is exerted on the thrust head 36 in the direction of the transition part 24b on the fixed component 24 vertically, and the direction of the forward force N3 is approximately vertical to the direction of the first module 12 and the second module 14 sliding in relative directions, when no force of sliding direction is provided to the thrust head 36, at this time, the thrust head 36 is at a state of a critical point, which means when the thrust head 36 is pushed slightly upwards to contact the first contact surface 26 of the fixed component 24, the thrust head 36 will then automatically slide to the first end 24a of the fixed component 24 to achieve the function of automatic opening; and when the thrust head 36 is pushed slightly downwards to contact the second contact surface 28 of the fixed component 24, the thrust head 36 will then automatically slide to the second end 24c of the fixed component 24 to achieve the function of automatic closing.

In the previously mentioned embodiment, the second module 14 is capable of moving above the first module 12 in a sliding manner, thus the user is able to push the second module 14 to achieve the opening action of the electronic device 10. In the present invention, the first module 12 is fixed above to the second module 14 in a sliding manner, the processing unit is installed within the second module 14, also the keypad 18 is installed on the casing of the second module 14, and the display panel 20 is installed on the first module 12. This differs from the previously mentioned embodiment in that the fixed component 24 of the semi-automatic opening mechanism is located above the thrust component 34, however, since the operation mechanism is similar to the first embodiment it will not be further mentioned.

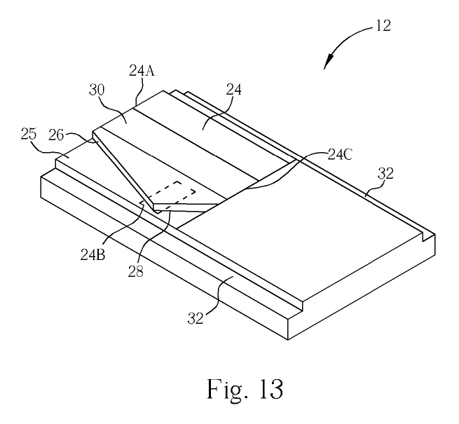

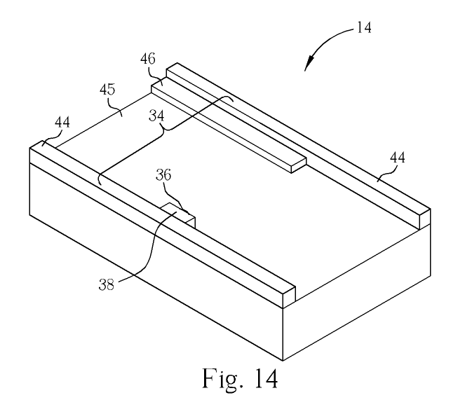

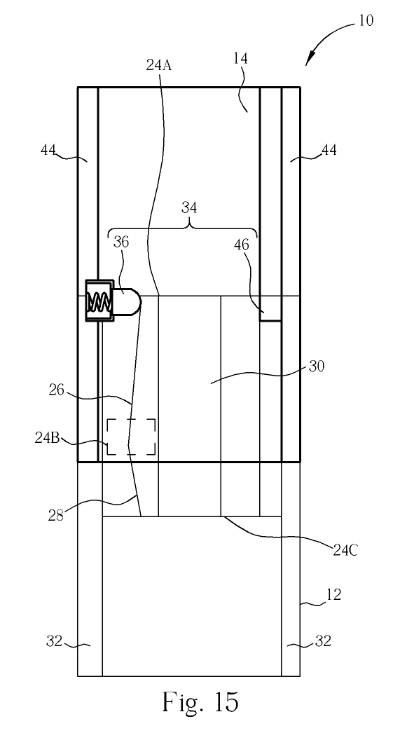

Furthermore, in the previously mentioned embodiment, in the fixed component 24 of the first module 12, a structure design is applied onto the widths of the front end 24a to the transition part 24b being gradually increasing, also the widths of the rear end 24c to the transition part 24b being gradually increasing. Please refer FIG. 13. FIG. 13 illustrates an internal structure diagram of a first module 12 of the second embodiment according the present invention. The fixed component 24 utilizes a structure design of widths of a front end 24a to a transition part 24b being gradually increasing, also widths of a rear end 24c to the transition part 24b being gradually increasing, therefore a thrust component 34 must comprise a group of thrust head 36 and force device 38, installed on a side of a transition part 24b of a corresponding fixed component 24, as shown in FIG. 14. FIG. 14 illustrates an internal structure diagram of a second module 14 of the second embodiment according to the present invention. In this way, utilization of a group of thrust head 36 and force device 38 can be reduced. Additionally, the second module 14 further comprises a contact component 46, for pushing against the first contact surface 26 and the second contact surface 28 of the fixed component 24 with the thrust component 34, as shown in FIG. 15. FIG. 15 illustrates a diagram of the first module 12 combining with the second module 14 of the second embodiment according to the present invention. The opening mechanism is similar to the first embodiment and therefore will not be further reiterated.

In comparison with the conventional opening mechanism of the electronic device, in the semi-automatic opening mechanism design of the present invention, when the user is opening or closing the electronic device, after manually surpassing a predetermined distance, the electronic device continues to execute the movement of opening or closing automatically, hence the present invention improves over the defect of the user needing to push the partial module to the upper end or lower end to completely open or close the electronic device, and the present invention allows the user to operate the electronic device, like a mobile phone, and so on, more conveniently. This provides convenience for the user operating the machine.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising:
a first module comprising a fixed component having a front end and a rear end, and a transition part located between the front end and the rear end, widths of the front end to the transition part being gradually increasing, widths of the rear end to the transition part being gradually increasing; and
a second module comprising a thrust component for pushing against a first contact surface of the fixed component between the front end and the transition part or pushing against a second contact surface of the fixed component between the rear end and the transition part.

2. The electronic device of claim 1 wherein the fixed component is located on a first flat surface of the first module, the second module comprising a second flat surface opposite to the first flat surface of the first module.

3. The electronic device of claim 2 wherein the second flat surface comprises a sliding track, and the thrust component is located on a first side of the sliding track.

4. The electronic device of claim 3 wherein the second module further comprises a contact component for pushing against the fixed component with the thrust component.

5. The electronic device of claim 1 wherein the first contact surface and the second contact surface are two inclined surfaces.

6. The electronic device of claim 1 wherein the first contact surface and the second contact surface are two curved surfaces.

7. The electronic device of claim 1 wherein the fixed component comprises a hole for a wire connecting between the first module and the second module to pass through.

8. The electronic device of claim 1 wherein the thrust component comprises:
a thrust head for contacting the first contact surface or the second contact surface; and
a force device for providing a thrust to the thrust head so that the thrust head pushes against the first contact surface or the second contact surface.

9. The electronic device of claim 8 wherein the thrust head is a bullet-shaped structure.

10. The electronic device of claim 8 wherein the force device is a spring.

11. The electronic device of claim 8 wherein the force device is an elastic structure.

12. The electronic device of claim 1 wherein the first module further comprises a processing unit for controlling operation of the electronic device and a keypad for inputting control signals to the processing unit.

13. The electronic device of claim 1 wherein the second module further comprises a display panel for displaying images.

14. The electronic device of claim 1 wherein the first module further comprises a display panel for displaying images.

15. The electronic device of claim 1 wherein the second module further comprises a processing unit for controlling operation of the electronic device and a keypad for inputting control signals to the processing unit.

16. The electronic device of claim 1 wherein the electronic device is a mobile phone.
